(19) United States
(12) Patent Application Publication
(10) Pub. No.: US 2024/0133154 A1
(43) Pub. Date: Apr. 25, 2024

(54) SYSTEM AND METHODS FOR UNDERWATER WORKS

(71) Applicants: Sarah Michal SAPIR, Houston, TX (US); Yoav SAPIR, Houston, TX (US)

(72) Inventors: Sarah Michal SAPIR, Houston, TX (US); Yoav SAPIR, Houston, TX (US)

(21) Appl. No.: 18/530,518

(22) Filed: Dec. 6, 2023

Related U.S. Application Data
(63) Continuation of application No. 16/643,865, filed on Mar. 3, 2020, now abandoned.
(60) Provisional application No. 62/558,367, filed on Sep. 14, 2017.

(51) Int. Cl. E02F 5/00; B25J 9/00; B63B 35/28; B63C 11/52; E02F 9/20

(52) U.S. Cl. CPC E02F 5/006; B25J 9/0009; B63B 35/28; B63C 11/52; E02F 9/205; E02F 3/963

(57) ABSTRACT

A system for performing underwater earthworks, the system including a power pack situated outside the water, at least one submersible operating unit for performing underwater earthworks, wherein the operating unit is connected with the power pack through power supply means, and a control unit connected via data communication means with the power pack and the operating unit and with instrumentation indicating location and depth of the operating unit.

### CROSS REFERENCE TO REPLATED APPLICATIONS

This application is a continuation of U.S. patent application Ser. No. 16/643,865 filed Mar. 3, 2020, which is a National Stage Entry of PCT/IL2018/051031 filed on Mar. 13, 2018 which claims the benefit of priority from U.S. Provisional Patent Application No. 62/558,367 filed 1 Sep. 14, 2017. The contents of the above applications are incorporated herein by reference in their entirety.

### TECHNICAL FIELD

The present invention relates to the field of earthworks. More specifically, the invention relates to a system and methods for earthwork when exist accessibility difficulties. More particularly, the invention deals with underwater earthworks.

### BACKGROUND ART

Performing earthworks in sites where there is exists complication in accessibility poses great difficulties especially while using heavy equipment. Underwater sites are inevitably difficult to access, and more hazardous, compared with working on dry land. In order to access the site directly, diving equipment and diving skills are necessary. The depths that can be accessed by divers, and the length of time available at depths, are limited. For deep sites beyond the reach of divers, submarines are sometimes used to carry equipment and tools. For a marine site, while some form of working platform (typically a boat or ship) is often needed, shore-based activities are common. Water dredge, cofferdams, and air lifts create additional hazards and logistics issues. Moreover, marine sites may be subject to strong tidal flows or poor weather. Cofferdams require attention to the interaction among the structure, the soil, and water. The loads acting on cofferdams' structures include water's hydrostatic forces and dynamic forces of currents and waves. Another example of designated equipment for underwater works is the caisson. However the “caisson disease” which is so named after an incident which occurred with construction workers when they left the compressed atmosphere of the caisson and rapidly re entered normal atmospheric conditions. This known case happened during the construction of the Brooklyn Bridge, which was built while using caissons, resulting in numerous workers being killed, others were harmed permanently by the caisson disease, including the designer's son and Chief Engineer of the project.

In many underwater works it is required to move rocks or other large objects from one place to another. Typically according to existing techniques this is done by at least two cranes and a team of divers as follows:
1. Using a crane, releasing of dumping bath with bulk of rocks or stones.
2. Lifting and separating each stone or rock out of the bulk, one by one, using a grabber cranes. This can take 2-3 minutes per each stone.
3. Tying each of the rocks, or each of the stones, to the cranes. One at a time. This is done by a team of divers, and typically requires additional minimum 4 minutes per each stone.
4. Placing the rock or the stone at a predefined place according to GPS. Usually there no way to control the exact placing with the existing equipment without divers.
5. Releasing of the stone or the rock from the cranes, at their required place.

However, difficulties with the existing techniques with cranes are enormous. These include hardships harmonizing between heavy equipment such as an awkward large crane outside the water and humans diving underwater. Not only it is very complicated, it is also hazardous. When the operating unit is outside the water, there is a need to use long cables to enable maneuver of objects such as rocks underwater. However, it is very hard to control maneuvering of an object hung on a cable, worse when the cable length is partially underwater. All this prolongs the time spent on the task and increases the costs.

### SUMMARY OF THE INVENTION

There is provided, in accordance with an embodiment of the present invention, a system for performing underwater earthworks. The system may include a power pack situated outside the water, at least one submersible operating unit for performing underwater earthworks connected to the power pack through power supply means, and a control unit connected via data communication means with the power pack, the operating unit and with instrumentation indicating location and depth of the operating unit.

In some embodiments, the submersible operating unit may be an excavator.

In some embodiments, the system may include a barge on which the power pack is installed. Additionally, the control unit may be installed on the barge.

In some embodiments, the said control unit is installed on the operating unit.

In some embodiments, the system may include a positioning unit. The positioning unit may include a GPS unit.

In some embodiments, the system may include a depth monitoring unit. The depth unit may include a sonar.

In some embodiments, the system may include a camera for viewing the work site.

In some embodiments, the system control unit may include a display screen.

In some embodiments, the power pack may supply electrical power. Additionally or alternatively, the power pack may supply hydraulic power. Additionally or alternatively, the power pack may supply mechanical power.

In some embodiments, the system may include a communication system to communicate between the power pack, the control unit, and the operating unit. The communication system may include wireless communications and/or wired communications.

There is provided, in accordance with an embodiment of the present invention, a method for performing underwater earthworks, the method may include situating an operating unit underwater and connecting the operating unit to a power pack through a power supply means. The method may additionally include connecting the operating unit and the power pack to a control unit. The method may further include connecting instrumentation with the control unit for determining and monitoring location and depth of the operating unit, and for monitoring and controlling the operation of the power pack and the operating unit.

In some embodiments, the method may additionally include installing the power pack on a barge. The method may additionally include installing the control unit on a barge.

### BRIEF DESCRIPTION OF DRAWINGS

FIG. 1 schematically illustrates an exemplary system for underwater works including a barge with a control station and a hydraulic power pack both installed on top of the barge, according to an embodiment of the present invention;

FIG. 2 schematically illustrates the exemplary system for underwater works including a submersible excavator with a grab, situated in an underwater work site while lifting a rock, according to an embodiment of the present invention;

FIG. 3 schematically illustrates a closer look of the grab of FIG. 2 while lifting a rock, according to an embodiment of the present invention;

FIG. 4 schematically illustrates a closer look of the grab of FIG. 2 while placing a rock, according to an embodiment of the present invention;

FIG. 5 schematically illustrates an exemplary system for underwater works including a first control station located in a submersible excavator, according to an embodiment of the present invention; and

FIG. 6 schematically illustrates an exemplary system for underwater works including a barge, a power pack mounted on the barge, a second control station located on the barge, and a submersible excavator, according to an embodiment of the present invention.

### DESCRIPTION OF EMBODIMENTS

Aspects of the present invention relate to a system for performing underwater works and may include at least one submersible operating unit, being powered by a power pack located outside the water, above water level, on land, or below water inside a submerged cabin. Typically, the underwater operating unit may be connected to the power pack with some kind of power supply means, such as cables, pipes, wires and so forth. Data communication among the operating unit, the control unit (of which may be called later also a control station), and the power pack may be performed by wire and/or wirelessly. The control unit may be connected via data communication with instrumentation indicating the location and the depth of the operating unit.

The power supplied by the power pack may be of various kinds, such as electric, mechanic, or hydraulic. The underwater operating units may be of various kinds such as cranes, bulldozers, drillers, rock crushers, loaders, graders, backhoes, excavators (diggers), reclaimers, shovels, suction excavators, trenchers, yarders, scrapers, forklifts, straddle carriers, tunnel boring machines (TBMs), orange-peel grabs, bulk-handling cranes and tamping machines. As may be understood a possible advantage of the system embodying the present invention is that much more power can be utilized underwater, compared with the existing techniques where only human divers are underwater while the heavy equipment is outside the water. Additionally, the system of the present invention would be much less vulnerable to high seas conditions and storms due to the location of the operation unit underwater and due to the reduced manpower, and optionally due to its ability to operate autonomously without divers using pre-programmed instructions. Thus, consecutive working days may be more frequent and less damage is expected to unfinished construction sections.

According to one embodiment of the present invention the underwater operating unit is a submersible 75 ton excavator which provides excellent stability underwater while handling a wide range of materials in different applications such as arrangement of underwater rocks and construction of harbors. Other excavator sizes may be selected such as 135, 65, 40 and 35 tons. Underwater excavators, according to embodiments of the present invention, are better suited compared to cranes as excavators are more agile, thus allowing performing tasks independently at remote sites, and also at locations where a crane, would not be able to reach. This may be especially true when the system, according to an embodiment of the present invention operates, optionally without divers, in a remote mode. In contrast to the use of cranes as in existing techniques, underwater excavators in systems embodying the present invention, facilitate collection and utilization of excess materials that would otherwise be left unused at site.

A system according to embodiments of the present invention may include a positioning unit (e.g. GPS), and a depth monitoring unit. According to some embodiments the underwater operating unit may include the GPS unit and the depth monitoring unit which may provide critical information to those above the water and assure that work is carried in the exact location. Additionally, the underwater positioning unit and the depth monitoring unit may enhance the mobility of the submersible operating unit around a greater area. A system in accordance with some embodiments of the present invention may include a camera for clear and live underwater viewing of the site and the operations, as well as in order to supervise the divers who work in the water. The camera views may be displayed on a wide screen at the control station out the water. In accordance with some embodiments of the present invention a sonar may be included as well.

The system according to embodiments of the invention may include several modes of operation: underwater by divers, remotely from outside of the water (with or without divers), or a combination of underwater and above water operations. The system may include an underwater screen which can may the location, for example according to GPS and points of reference of locations where the divers should work. The live control display screen outside the water facilitates remote control of the submersible unit as well as monitoring divers that are working underwater. It should be noted that the control station may be located on-site, at a vicinity to the site, or far away, above the water, on land, underwater, or hovering above. It may be expected in some cases, especially when the control station is remotely located, that internet may be used for communication.

In some cases when utilizing positioning units and depth monitoring units according to embodiments of the present invention, great improvement of the accuracy of the operations may be achieved. In some cases it may be expected that an improvement in accuracy may be achieved especially when the positioning unit and the depth monitoring unit are installed underwater, preferably on the operating unit. Thus, it may become possible to unify operations. For example, when use of an excavator according to an embodiment of the present invention, it may be possible in some cases, to unify steps 2-5 that were mentioned in the background. This can potentially bring a saving in time and costs. In some cases one system according to the present invention may replace two or more cranes which are used according to the existing techniques. A system according with some embodiments of the present invention may include robotics and artificial intelligence features. The system may be completely autonomous and may optionally not require use of an operator in the excavator and/or in the control station. For example, the system's computer may be programmed with information associated with the work location and work spot (for example based on GPS), and the average work depth. Additionally or alternatively, according with particular embodiments of the present invention, systems may include an option for operation of excavators underwater by a diver. Such systems may include an underwater control station which may be next to the excavator or part of the excavator. Using systems according to embodiments of the present invention may free up working space above the water level. The system, according to some embodiments of the present invention, may include means to supply power to other system equipment which may be hydraulically operated. The underwater equipment and optionally the above water equipment may include one or more connectors, optionally quick-connect/release connectors, suitable to allow the hydraulic equipment to be powered by other hydraulic equipment. Examples of the hydraulic equipment which may be powered may include pumps, cutting machines, and drills among other equipment which may operate as part of a suitable underwater work platform to assist divers.

A method according to aspects of the present invention may include the following steps:
situating at least one operating unit underwater;
connecting the above at least one operating unit to a power pack through power supply means;
connecting the operating unit and the power pack with a control unit;
connecting instrumentation with the control unit for determining and monitoring the location and the depth of the operating unit; and
monitoring and controlling the operation of the power pack and the operating unit through the control unit.

For enhancing the understanding of the present invention, an embodiment of the present invention is being schematically illustrated in the attached figures along with the below reference explanations.

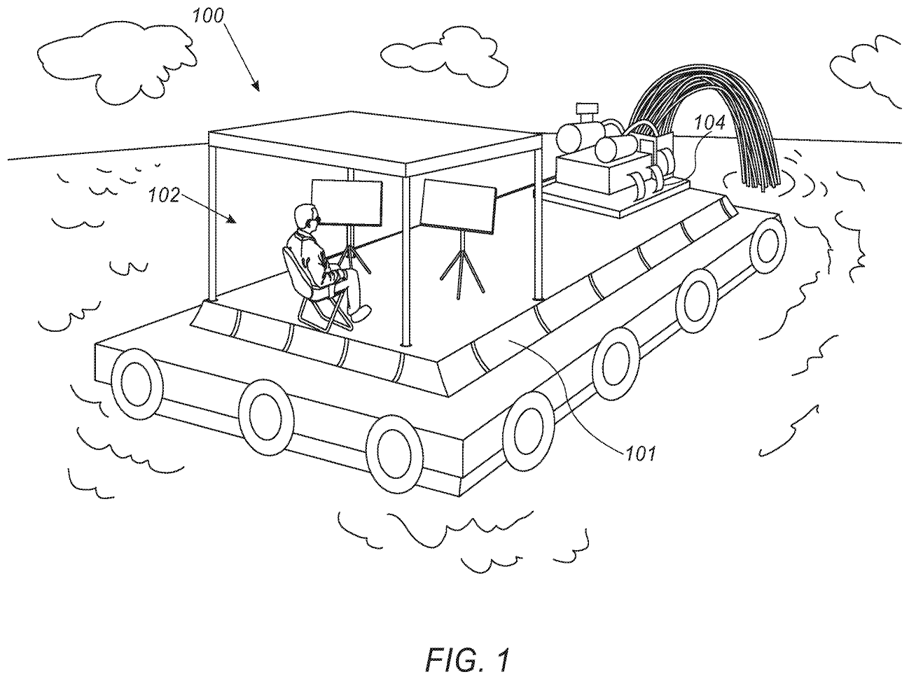

FIG. 1 depicts a barge 101 included in a system 100 according to an embodiment of the present invention. On top of the barge 10 there are installed a control station 102 and a hydraulic power pack 104.

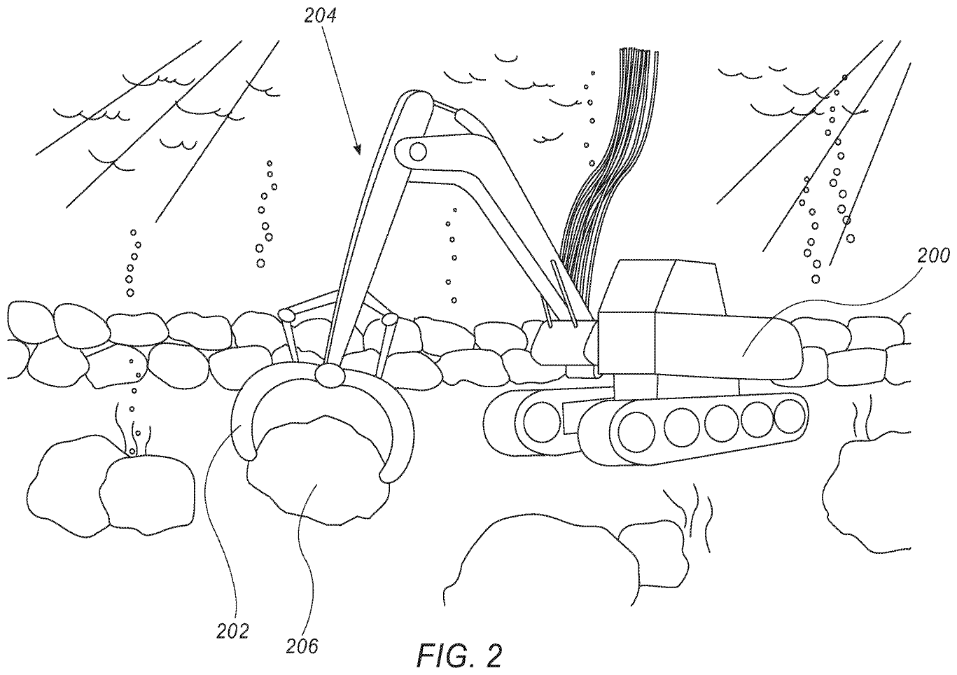

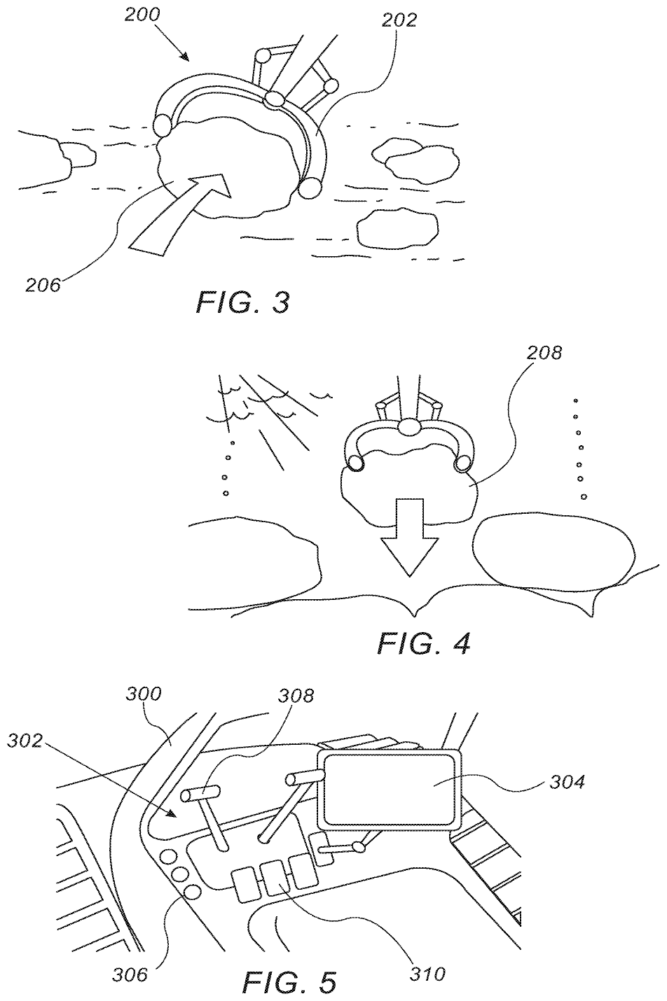

FIG. 2 depicts a submersible excavator 200 with a grab 202 situated in an underwater work site 204 while lifting a rock 206, according to an embodiment of the present invention. FIG. 3 shows a closer view of the grab 202 of the submersible excavator 200 while lifting the rock 206, according to an embodiment of the present invention. FIG. 4 shows a similar closed look but while a placement of a rock 208 is carried out, according to an embodiment of the present invention.

FIG. 5 shows an underwater control station 302 in a submersible excavator 300 where a view panel 304 is installed to display input received from cameras and from other instrumentation which may enhance the work of the control operator, according to an embodiment of the present invention. Also shown in FIG. 5 are knobs 306, levers 308, and pedals 310 similar to those of which can be found in a standard excavator, however, all parts are adapted to work underwater.

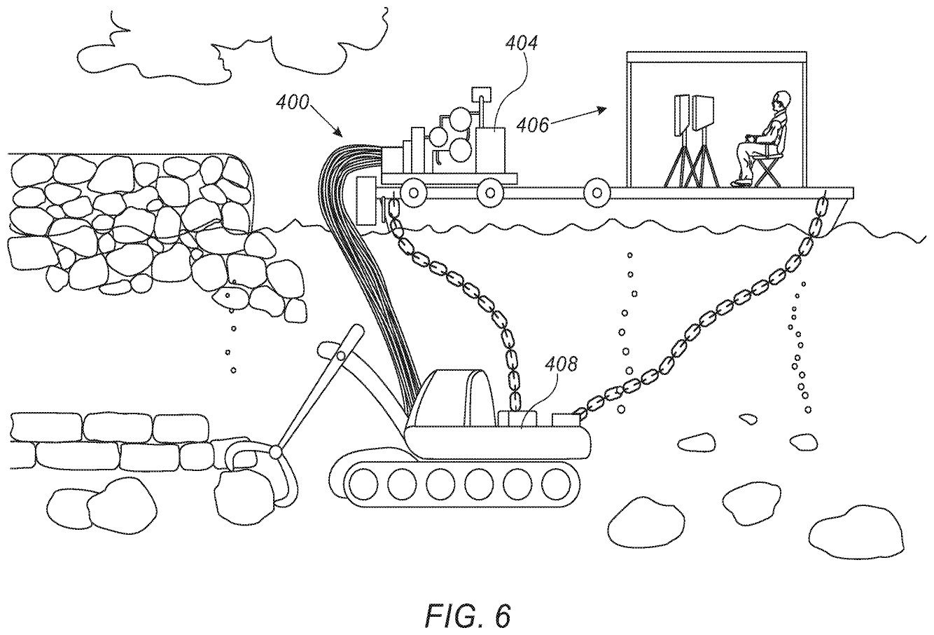

FIG. 6 depicts an overall look at a system 400 which includes a barge 402, a power pack mounted 404 on the barge, a second control station located on the barge 406, and submersible excavator 408, according to an embodiment of the present invention.

While in accordance with the provisions of the statutes we have illustrated and described herein a specific form of the invention now known to us, those skilled in the art will understand that changes may be made in the form of the apparatus and method of the operation disclosed without departing from the spirit of the invention covered by our claims, and that certain features of the invention may sometimes be used to advantage without corresponding use of other features. The foregoing description and illustrations of the embodiments of the invention has been presented for the purposes of illustration. It is not intended to be exhaustive or to limit the invention to the above description in any form.

1. A system for performing underwater earthworks, said system comprising:
a power pack installed on a barge and situated outside the water;
at least one submersible excavator for performing underwater earthworks, wherein said at least one submersible excavator is configured to lift underwater rock and is connected with said power pack through power supply means that are cables connected on one end to the excavator and on the other end of the power pack;
a first control station connected via data communication means with said power pack and said operating unit and with instrumentation indicating location and depth of said operating unit, said first control station being installed on said operating unit.

2. The system of claim 1, further comprising a second control station, the second control unit installed on said barge.

3. The system of claim 1, further comprising a positioning unit.

4. The system of claim 3, wherein said positioning unit comprises a GPS unit.

5. The system of claim 1, further comprising a depth monitoring unit.

6. The system of claim 1, further comprising a camera for viewing the work site.

7. The system of claim 1, wherein said control unit comprises a display screen.

8. The system of claim 1, further comprising a sonar.

9. The system of claim 1, wherein said power pack supplies electrical power.

10. The system of claim 1, wherein said power pack supplies hydraulic power.

11. The system of claim 1, wherein said power pack supplies mechanical power.

12. The system of claim 1, further comprising a communication systems to communicate between said power pack, said control unit, and said operating unit.

13. The system of claim 12 wherein said communications system comprises wireless communications.

14. The system of claim 12 wherein said communications system comprises wired communications.

15. A method for performing underwater earthworks, said method comprising:
situating at least one operating unit underwater;
installing a power pack on a barge;
connecting said at least one operating unit to said power pack through a power supply means;
connecting said operating unit and said power pack to a control unit;
connecting instrumentation with the control unit for determining and monitoring location and depth of the operating unit; and
monitoring and controlling the operation of said power pack, and said operating unit through utilizing said control unit,
wherein said operating unit is an excavator configured to lift underwater rock, and
wherein said power supply means are cables connected on one end to the excavator and on the other end of the power pack.

16. The method of claim 15, further comprising installing said control unit on said barge.

17. A system for performing underwater earthworks, said system comprising:
a power pack installed on a barge and situated outside the water;
at least one submersible operating unit for performing underwater earthworks, wherein said operating unit is an excavator configured to lift underwater rock and connected with said power pack through power supply means, said at least one submersible operating unit chained to said barge; and
a control unit connected via data communication means with said power pack and said operating unit and with instrumentation indicating location and depth of said operating unit.

18. The system of claim 17, wherein the control unit is a first control station installed on said excavator.

19. The system of claim 18, further comprising a second control station, the second control unit installed on said barge.
